(19) United States
(12) Patent Application Publication
(10) Pub. No.: US 2009/0086596 A1
(43) Pub. Date: Apr. 2, 2009

(54) RECORDING UNIT AND METHOD OF RECORDING ON RECORDING MEDIUM

(75) Inventor: Manabu Nomoto, Hachioji-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/190,874

(22) Filed: Aug. 13, 2008

(30) Foreign Application Priority Data
Sep. 28, 2007 (JP) 2007-255028

(51) Int. Cl. G11B 7/00

(52) U.S. Cl. 369/47.53; G9B/7

(57) ABSTRACT

According to one embodiment, a recording unit includes a recording unit for recording data on a recording medium, a laser light source for emitting a laser when data is recorded on the recording medium, a flash memory for storing a previously measured output characteristic of the laser light source, and a control unit for controlling the recording unit, wherein the recording unit comprises a selection unit which performs test writing on the recording medium, and selects an optimum laser power from a reproducing signal waveform of the written data when data is recorded on the recording medium, and the control unit comprises a correction unit which reads an output characteristic of the laser light source from the flash memory, and corrects a value of a reference laser power when the selection unit performs test writing.

### CROSS-REFERENCE TO RELATED APPLICATIONS

This application is based upon and claims the benefit of priority from Japanese Patent Application No. 2007-255028, filed Sep. 28, 2007, the entire contents of which are incorporated herein by reference.

### BACKGROUND

1. Field

One embodiment of the present invention relates to a recording unit and a method of recording on a recording medium.

2. Description of the Related Art

In a recording unit including an optical disc apparatus, for example, before starting the recording on an optical disc as a recording medium, OPC (Optimum Power Control) is performed to adjust a laser recording power according to the recording sensitivity of disc film, temperatures and changes in the recording state by fluctuations in a laser wavelength. In the OPC, test writing is made by several laser recording powers in a PCA (Power Calibration Area) formed at the inner radius of a disc, the written part for test is read out, and an optimum laser recording power is found based on a certain evaluation standard.

When a laser recording power is changed, a fixed value set for each recording medium is used as a reference laser recording power, based on a table stored in an optical disc apparatus.

When a laser power of a pickup incorporated in an optical disc apparatus does not conform to the product specifications, a laser recording power used for the test writing does not reach a desired value, and a long time may be required to find an optimum laser recording power, or the OPC may fail. Namely, stable OPC is difficult, and the quality of recording may be decreased.

In the prior art, it is proposed that a reference voltage value corresponding to a light-emitting power is set based on a value obtained in a production process, and the level of light amount is adjusted by emitting light (refer to Jpn. Pat. Appln. KOKAI Publication No. 2005-63546). In this recording unit, a reference voltage value is used as a reference voltage for a comparator of an APC unit, and is used for obtaining a maximum value of setting voltage. By changing the maximum value of setting voltage, an electric current is supplied as much as possible as a maximum value of LD driving current. Further, as a resolution is changed, a setting error is decreased.

However, in the above case, only the setting error can be decreased based on the LD driving current, and it is difficult to stabilize the range of changing a laser power in OPC.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram schematically showing an example of the configuration of a recording unit according to an embodiment of the invention;

FIG. 2 is an exemplary graph showing an example of the inspection result of a pickup of the recording unit shown in FIG. 1, before incorporating in the recording unit;

FIG. 3 is an exemplary graph for explaining an example of a method of obtaining a reference laser recording power for test writing on a recording medium, according to the inspection result shown in FIG. 2;

FIG. 4 is an exemplary view for explaining an example of a method of finding an optimum laser recording power from a reproducing signal waveform of the test written data on a recording medium;

FIG. 5 is an exemplary view showing an example of the reproducing signal waveform of the test written data recorded on a recording medium;

FIG. 6 is an exemplary view for explaining an example of a method of finding an optimum laser recording power from a reproducing signal waveform when data is recorded on a recording medium by a laser power after correction;

FIG. 7 is an exemplary view for explaining an example of a method of finding an optimum laser recording power from a reproducing signal waveform when data is recorded on a recording medium by a laser power without correction;

FIG. 8 is an exemplary flowchart for explaining an example of an inspection process to be executed before the pickup of the recording unit shown in FIG. 1 is incorporated in the recording unit; and

FIG. 9 is an exemplary flowchart for explaining an example of a method of correcting a reference laser recording power for test writing on a recording medium, when OPC is performed in the recording unit shown in FIG. 1.

### DETAILED DESCRIPTION

Various embodiments according to the invention will be described hereinafter with reference to the accompanying drawings. In general, according to one embodiment of the invention, there is provided a recording unit comprising a recording means for recording data on a recording medium; a laser light source for emitting a laser when data is recorded on the recording medium; a memory for storing a previously measured output characteristic of the laser light source; and a control means for controlling the recording means, wherein the recording means comprises a selection means which performs test writing on the recording medium, and selects an optimum laser power from a reproducing signal waveform of the written data when data is recorded on the recording medium, and the control means comprises a correction means which reads an output characteristic of the laser light source from the memory, and corrects a value of a reference laser power when the selection means performs test writing.

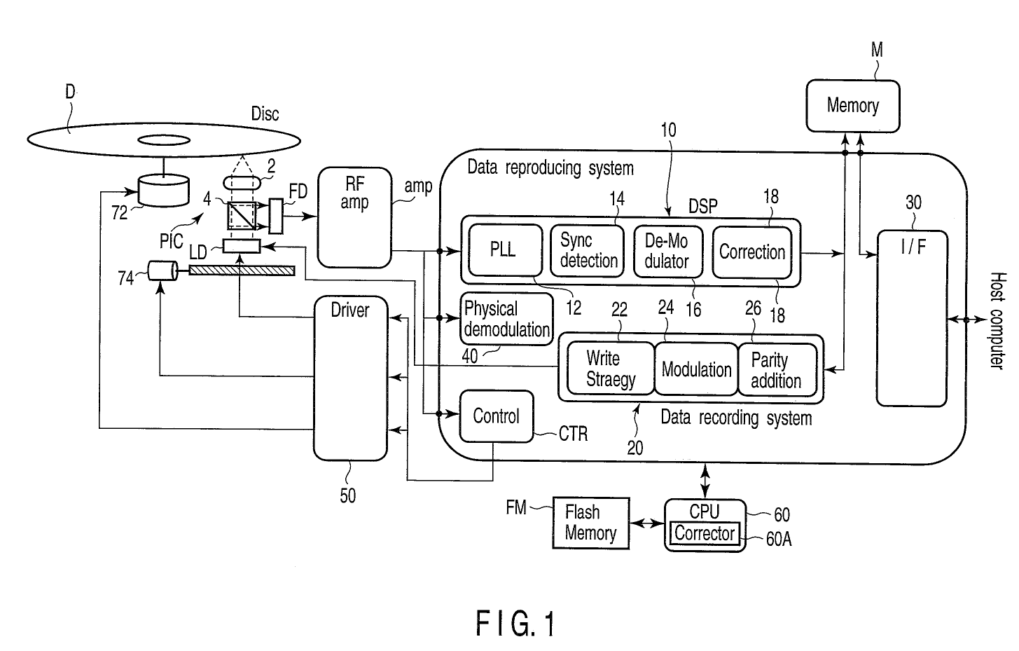

Hereinafter, an explanation will be given on a recording unit and a method of recording on a recording medium according to an embodiment of the invention, with reference to the accompanying drawings. As shown in FIG. 1, a recording unit according to this embodiment is an optical disc apparatus for recording and reproducing information on/from an optical disc D as a recording medium. The optical disc apparatus according to the embodiment comprises a data reproducing unit 10, a data recording unit 20, a pickup PIC as a laser light source to emit a laser when recording and reproducing data on/from an optical disc D, a flash memory FM to store a previously measured output characteristic of the pickup PIC, and a CPU 60 as a control means to control the data reproducing unit and data recording unit 20.

An optical disc D comprises a groove formed concentric or spirally. A recessed portion of the groove is called a land, and a projected portion is called a groove, and a one circle of land or groove is called a track. User data is recorded by applying an intensity-modulated laser along a track (only a groove, or a groove and a land), and forming a record mark.

Data is reproduced by applying laser light having a read power weaker than record power along a track, and detecting a change in the intensity of the light reflected from a record mark formed on a track. Recorded data is erased by applying laser light having an erase power stronger than the read power, and crystallizing a recording layer.

The optical disc is rotated by a spindle motor 72. Information is recorded and reproduced on/from the optical disc D by the pickup PIC. The pickup PIC is connected through a feed motor 74, a gear, and a screw shaft. When the feed motor 74 is rotated with a motor driving current from a driver 50, the pickup PIC is moved in the radial direction of the optical disc D.

The pickup PIC is provided with an objective lens 2 supported by a not-shown wire or a leaf spring. The objective lens 2 is driven by a driving coil (not shown), and is movable in a focusing direction (the optical axis direction of the lens 2). The objective lens 2 is driven by a driving coil (not shown), and is movable in a tracking direction (the direction orthogonal to optical axis of the lens 2).

A control unit CTR controls and causes the driver 50 to supply a writing signal to a laser diode (a laser-emitting element) LD as a laser light source, based on the recording data supplied from a host computer through an interface circuit 30, when information is recorded on the optical disc D (when a record mark is formed).

The laser diode LD emits laser light corresponding to a driving current supplied from the driver 50. The laser light emitted from the laser diode LD is applied to the optical disc D through a half prism 4 and the objective lens 2. The reflected light from the optical disc D is guided to a photodetector FD through the objective lens 2 and half prism 4.

The photodetector FD consists of a 4-divided photodetector cell, for example. A detection signal of the photodetector cell is output to a RF amplifier AMP. The RF amplifier AMP processes the signal from the photodetector cell, and outputs the processed signal to the data reproducing unit 10, physical demodulator 40, and control unit CTR.

The data reproducing unit 10 receives a reproducing signal as total addition of a photodetector cell signal generated in the photodetector FD. The control unit CTR generates control signals, such as a focus error signal indicating a deviation from a focusing point position, and a tracking error signal indicating a deviation of the beam spot center of a laser beam from the center of a track, and drives the driver 50 according to such control signals.

The driver 50 generates a focus driving signal according to a focus error signal. A focus error signal is supplied to a driving coil for focusing, whereby focus servo is performed, and laser light is always just focused on the recording film of the optical disc D.

The driver 50 generates a tracking drive signal according to a tracking error signal. A tracking drive signal is supplied to a driving coil for tracking, whereby tracking servo is performed, and laser light always traces on a track formed on the optical disc D.

By the above focus servo and tracking servo, the total addition signal of the output signal of each photodetector cell of the photodetector FD reflects a change in the reflected light from a record mark formed on a track of the optical disc D corresponding to the recording information. This signal is supplied to the data reproducing unit 10. The data reproducing unit 10 comprises a PLL (Phase-locked loop) unit 12, a synchronism detector 14, a demodulator 16, and a corrector 18.

The PLL unit 12 generates a clock signal for reproduction, based on the reproducing signal input from the RF amplifier AMP. The synchronism detector 14 synchronizes the reproduction signal, based on the clock signal generated in the PLL unit 12, and the demodulator 16 demodulates the reproducing signal. The corrector 18 compares the demodulated reproducing signal with parity, and corrects the reproducing signal. The reproducing signal output from the data reproducing unit 10 is stored in a memory M, and output to a host computer through the interface circuit 30.

When information is recorded on the optical disc D, the information stored in the memory through the interface circuit 30 is processed in the data recording unit 20. The data recording unit 20 comprises a parity adder 26, a demodulator 24, and a power selector 22.

The parity adder 26 adds parity information used for correcting an error at the time of reading the recorded information, to the information read from the memory M. The demodulator 24 demodulates the information including the added parity information.

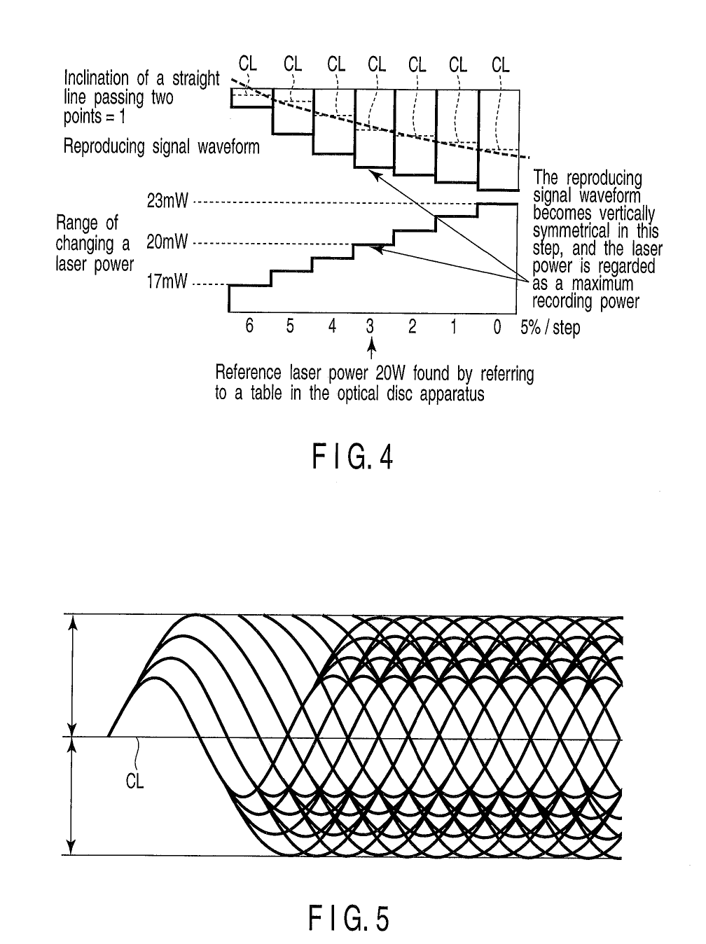

The power selector 22 performs OPC to select an optimum magnitude of a laser recording power, when information is recorded on an optical disc. For example, as shown in FIG. 4, a laser recording power is changed in six steps, for example, and test writing is performed on the optical disc D. At this time, a fixed value set for each recording medium is used as a reference laser recording power at the time of changing a laser recording power, based on a table stored in an optical disc apparatus, for example. In the case shown in FIG. 4, a reference value of laser recording power is assumed to be 20 mW, and a laser recording power is changed in a range of 17 mW to 23 mW.

The data recorded by each laser recording power is reproduced, a laser recording power 0, at which the obtained reproducing signal waveform becomes vertically symmetrical to the threshold value CL, is found, and that laser recording power is regarded as an optimum laser recording power.

In the optical disc apparatus of this embodiment, the data obtained by the inspection of the pickup PIC performed previously is stored in the flash memory FM, and a value of current input to the pickup PIC upon execution of OPC is corrected by using this inspection data.

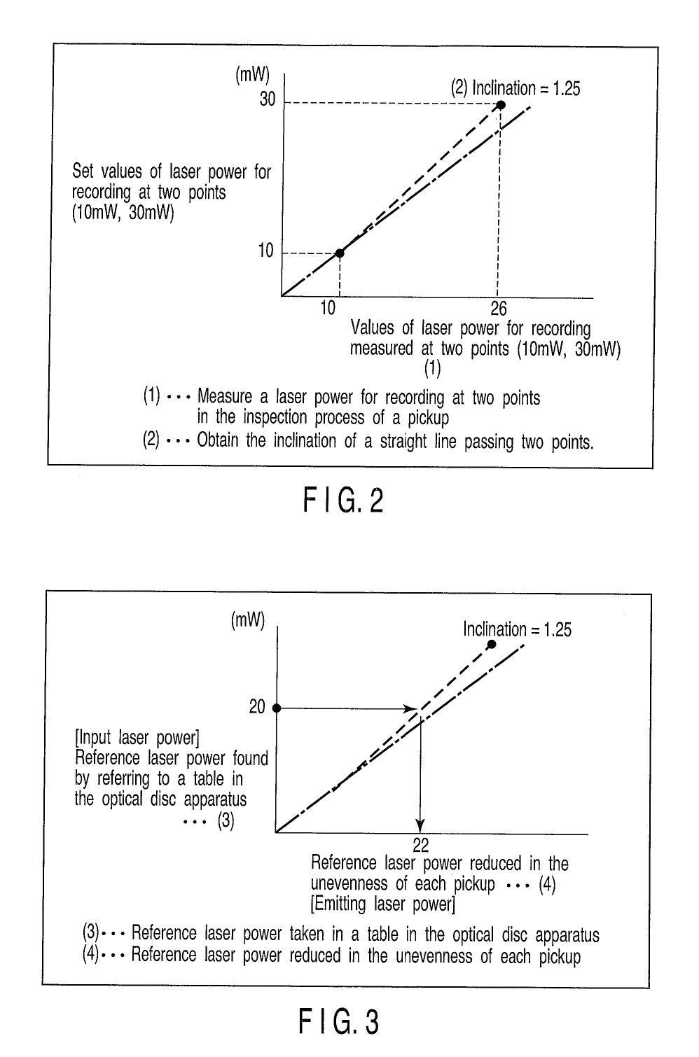

Namely, before the pickup PIC is incorporated in the optical disc apparatus, whether a desired laser power can be obtained for each pickup PIC is checked. For example, as shown in FIG. 2, a measurement result not conforming to a specified laser power may be obtained for the pickup PIC. In the case of FIG. 2, even if the pickup PIC emits a laser power of 30 mW according to the specification, the obtained measurement result indicates that the actually emitted laser recording power is 26 mW.

When OPC is performed in an optical disc apparatus provided with a pickup PIC having the output characteristic not conforming to the specifications shown in FIG. 2, even if a laser is emitted from the pickup PIC in a predetermined range including the reference laser recording power, test writing is actually performed by a different laser recording power.

Therefore, even if a laser recording power vertically symmetrical to the threshold value CL is found in the reproducing signal waveform of the recorded data, that laser recording power may not be optimum. Further, as a desired laser power is not emitted, much time is required to find an optimum laser recording power, and OPC may fail.

In the optical disc apparatus of this embodiment, the control unit 60 comprises a corrector 60A which corrects a reference laser recording power for OPC performed by the power selector 22, as shown in FIG. 2 and FIG. 3, when a pickup PIC having the output characteristic not conforming to the specifications is incorporated in the optical disc apparatus.

Namely, when a pickup PIC has the output characteristic shown in FIG. 2, the corrector 60A of the CPU 60 makes correction as shown in FIG. 3. The corrector 60A corrects a specified current value so that a current value that corresponds to a laser recording power of 22 mW is input to a pickup PIC in order to obtain a reference laser recording power (20 mW).

Concretely, the corrector 60A calculates the inclination of a previously set laser power of a pickup PIC with respect to a previously measured laser power output from a pickup PIC, from a laser power value of the pickup PIC stored in the flash memory FM. In the optical disc apparatus according to the embodiment, as shown in FIG. 2 and FIG. 3, the inclination value calculated in the corrector 60A becomes 1.25 ((30−10)/(26−10)). For example, when the set reference laser recording power value is 20 mW, the corrector 60A calculates a reference laser recording power of 22 mW after correction, from this inclination value.

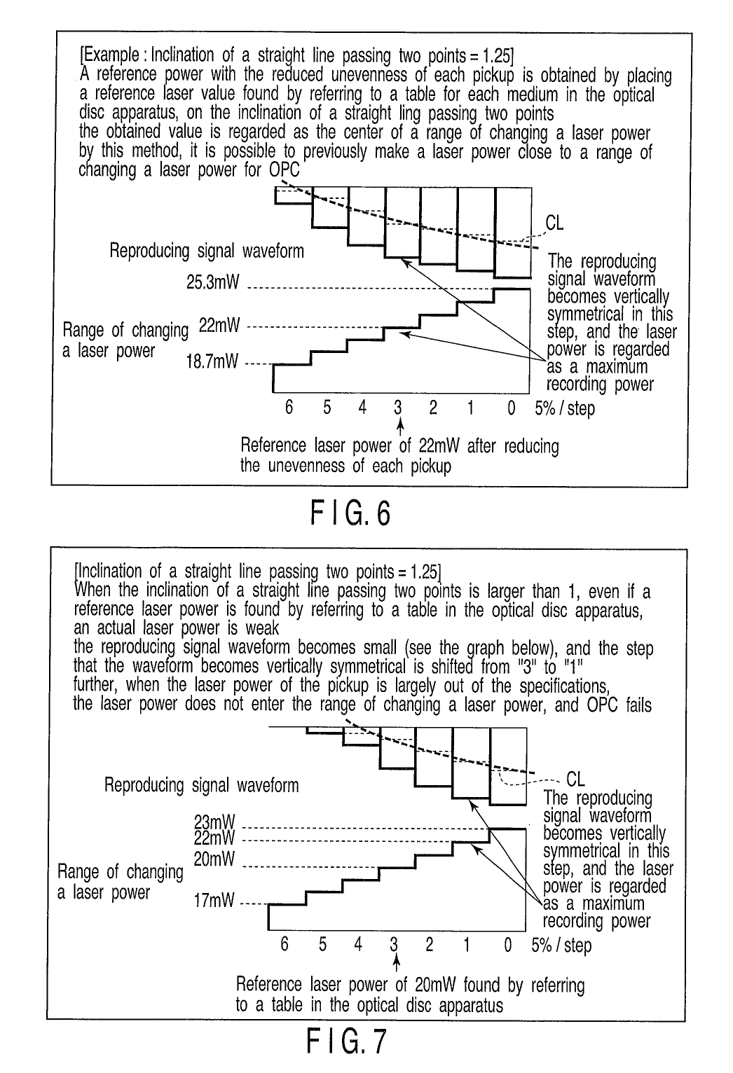

By the above correction, even the output of the pickup PIC does not conform to the specifications, as shown in FIG. 6, a reference laser recording power value for OPC becomes 22 mW, and a range of changing a laser recording power becomes 18.7 mW to 25.3 mW.

In the optical disc apparatus according to the embodiment, the pickup PIC has the output characteristic shown in FIG. 2, and by making the above correction, the pickup PIC can actually emit a reference laser recording power of 22 mW, a range of changing a laser recording power becomes 18.7 mW to 25.3 mW, and the pickup PIC can output laser light having a desired laser recording power.

Therefore, even if a pickup PIC having the output characteristic shown in FIG. 2 is incorporated in the optical disc apparatus, an optimum laser recording power can be selected by finding a laser recording power vertically symmetrical to the threshold value CL, in the reproducing signal waveform of the data recorded as a test by each laser recording power, as shown in FIG. 6.

Namely, by correcting a current value input to the pickup PIC upon test writing of OPC, the time required to perform OPC can be reduced, and the failure of OPC can be avoided. As a result, according to the embodiment, there is provided a recording unit which can perform stable OPC, and increase the quality of recording.

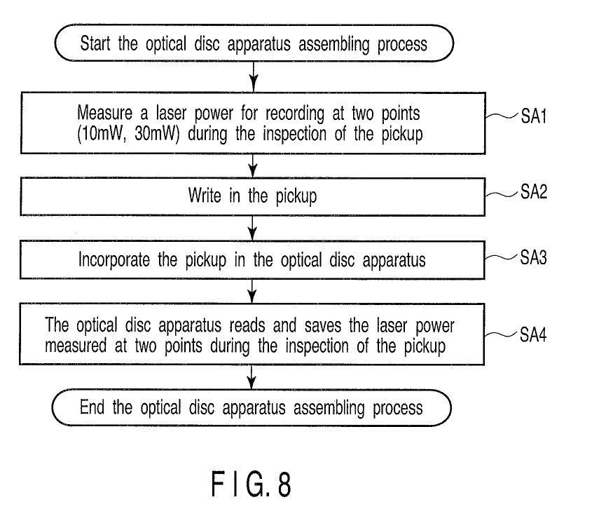

Next, an explanation will be given on an optical disc recording method in the optical disc apparatus described herein. First, an explanation will be given on a process of assembling the optical disc apparatus according to the embodiment, before start of recording on an optical disc as shown in FIG. 8.

A pickup PIC is inspected, and a laser power recorded during the inspection is measured at two points (step SA1). In the embodiment, a laser power is measured at two points, for example, when a current capable of providing an output of 10 mW in specifications is input to a pickup PIC, and when a current capable of providing an output of 30 mW in specifications is input to a pickup PIC.

Next, each pickup PIC is given a two-dimensional code capable of reading the values of laser power measured at two points, the measurement result is written in the pickup PIC (step SA2), and the pickup PIC is incorporated in the optical disc apparatus (step SA3). The optical disc apparatus is assembled as described above, and the values of laser power at two points read from the two-dimensional code given to the pickup PIC are stored and saved in the flash memory FM (step SA4).

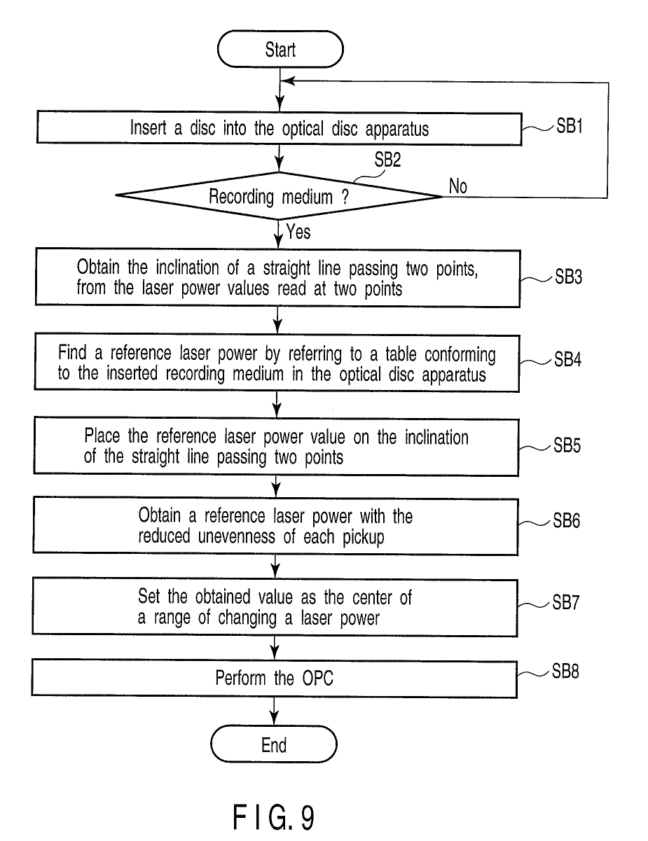

Next, an optical disc is recorded, as shown in FIG. 9. Namely, first, an optical disc D to record information is inserted into the optical disc apparatus (step SB1). Next, the CPU 60 judges whether the inserted optical disc D is a recording medium or not (step SB2). When the optical disc D is a recording medium, the corrector 60A gains the value of the inclination of a previously set output laser power of the laser light source with respect to a previously measured output laser power of the laser light source, and the value of the inclination of a straight line passing the two points, from the values of laser power at two points stored in the memory M (step SB3).

Next, a reference laser recording power applicable to the inserted recording medium is obtained by referring to the table stored in the optical disc apparatus (step SB4). And, as shown in FIG. 3, the value of the laser recording power is obtained by placing the value of the referenced reference laser recording power on the straight line passing the two points of laser power value (step SB5).

Next, the obtained laser recording power is regarded as a reference laser recording power (step SB6), and a predetermined range including that reference value is taken as a range of laser recording power for test writing on the optical disc D (step SB7). In the optical disc apparatus according to this embodiment, the optical disc D is set for test writing on the optical disc D in a predetermined range around the value of reference laser recording power after the correction. Test writing is performed on a recording medium in the set range of laser recording power, and OPC is performed (step SB8).

By making the correction as described above, even if a pickup PIC having the output characteristic shown in FIG. 2 is incorporated in the optical disc apparatus, an optimum laser recording power can be selected by finding a laser power vertically symmetrical to the threshold value CL, from the reproducing signal waveform of the data recorded as a test by each laser recording power, as shown in FIG. 6.

Namely, by correcting a current value input to a pickup PIC upon test writing of OPC by using a value measured in the inspection process of the pickup PIC as described above, the time required to perform OPC can be reduced, and the failure of OPC can be avoided. As a result, according to the recording unit of this embodiment, there is provided a method of recording on a recording medium, which can perform stable OPC, and increase the quality of recording.

Further, by making the correction as described above, a predetermined range around a reference laser recording power for test writing on a recording medium can be set narrower than the conventional range. Therefore, the optical disc apparatus and optical disc recording method according to this embodiment are effective particularly for a recording medium, in which a wide range of laser recording power cannot be taken for OPC.

Further, as a predetermined range around a reference laser recording power for test writing on a recording medium can be set narrower than the conventional range, the manufacturing yield of the optical disc apparatus can be improved.

Further, as a predetermined range around a reference laser recording power for test writing on a recording medium can be set narrower than the conventional range, when the vertical symmetry of a reproducing signal waveform is obtained in the power selector 22, the vertical symmetry can be obtained in a part having shaped lines of the waveform, and the recording quality can be improved.

Further, by making the above correction, it becomes unnecessary to previously learn an optimum laser recording power. As a result, the number of steps can be decreased in the optical disc apparatus manufacturing process, and the number of optical discs used for learning can be decreased.

The present invention is not limited to the embodiment described herein. The invention may be embodied in other specific forms by deforming the components in a practical step without departing from its spirit or essential characteristic.

The invention may be embodied in various forms by appropriately combining the components disclosed in the embodiment described herein. For example, some components may be deleted from the total components shown in the embodiment. Further, the components used in different embodiments may be appropriately combined.

While certain embodiments of the inventions have been described, these embodiments have been presented by way of example only, and not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A recording unit comprising: a recording means for recording data on a recording medium;
a laser light source for emitting a laser when data is recorded on the recording medium;
a memory for storing a previously measured output characteristic of the laser light source; and
a control means for controlling the recording means,
wherein the recording means comprises a selection means which performs test writing on the recording medium, and selects an optimum laser power from a reproducing signal waveform of the written data when data is recorded on the recording medium, and
the control means comprises a correction means which reads an output characteristic of the laser light source from the memory, and corrects a value of a reference laser power when the selection means performs test writing.

2. The recording unit according to claim 1, wherein the output characteristic of the laser light source recorded in the memory is a value of an output laser power when a predetermined input signal is input to the laser light source, and
the correction means calculates a value of inclination of a previously set output laser power of the laser light source with respect to a previously measured output laser power of the laser light source, from said two output laser power recorded in the memory, and selects an optimum laser power from the value of inclination when data is recorded on the recording medium.

3. A method of recording on a recording medium comprising: a step of reading a previously measured output characteristic of a laser light source from a memory;
a step of referring to a reference laser power in a table when data is recorded on a recording medium;
a step of correcting a value of the reference laser power according to the output characteristic;
a step of test writing on the recording medium by a laser power in a predetermined range including the reference laser power after the correction; and
a step of selecting an optimum laser power from a reproducing signal waveform of the data recorded by the test writing when data is recorded on the recording medium.

4. The method of recording on a recording medium according to claim 3, wherein the correction step comprises a step of reading an output characteristic of the laser light source, and a laser power value when a predetermined input signal is input to the laser light source,
a step of calculating a value of inclination of a previously set output laser power of the laser light source with respect to a previously measured output laser power of the laser light source, from said two output laser power recorded in the memory, and
a step of correcting the reference laser power value from the value of inclination.

5. The method of recording on a recording medium according to claim 3, wherein test writing is performed on the recording medium in a predetermined range around the reference laser power, in the test writing step.
